(19) United States
(12) Patent Application Publication
(10) Pub. No.: US 2005/0281933 A1
(43) Pub. Date: Dec. 22, 2005

(54) Hard frozen food containing alcohol

(76) Inventor: John B. Squicciarini, Aliso Viejo, CA (US)

Correspondence Address: FISH & RICHARDSON, PC, 12390 EL CAMINO REAL, SAN DIEGO, CA, 92130-2081, US

(21) Appl. No.: 11/156,201

(22) Filed: Jun. 17, 2005

Related U.S. Application Data
(60) Provisional application No. 60/580,672, filed on Jun. 17, 2004.

(51) Int. Cl. A23G 9/00

(52) U.S. Cl. 426/565

(57) ABSTRACT

The present invention is directed to a frozen beverage having a combination of a drug and a gelling agent. The combination is generally maintained at a temperature of 120 degrees F. for at least one minute before completing the remaining steps. In a preferred embodiment, the frozen beverage is hard frozen in the form of a pop and contains ethyl alcohol as the drug and pectin as the gelling agent.

### CROSS REFERENCE TO RELATED APPLICATIONS

The present application claims priority under 35 U.S.C. §119 to U.S. Provisional Application Ser. No. 60/580,672, filed Jun. 17, 2004, the disclosure of which is incorporated herein by reference

### BACKGROUND

Alcoholic frozen drinks are typically formed as “soft ice” or slushy beverages. Such drinks are usually prepared by blending alcohol, ice, and a drink mix in a blender. The result is a thick cold drink with small pieces of ice. It became known to sell such drinks in a ready-made form that did not need to have the ice or alcohol blended in. Such drinks only needed to placed in a freezer for a certain period of time before being consumed. Ready-made frozen alcoholic drinks melt quickly, especially in warm temperatures, and refreezing is not a viable alternative since the alcohol and water tend to separate upon melting and thereafter remain separated.

It has now become known to include alcohol into a frozen gelatin type food. For example, one type of product includes a mixture of vodka (or other alcoholic beverage) mixed with a prepared gelatin before being frozen. These alcoholic gelatin products are made by adding alcohol after the gelatin has been heated, but before refrigerating. However, alcoholic gelatin deserts do not freeze to a sufficient hardness to be held securely on a stick.

Several attempts have been made to produce a frozen beer or wine stick that freezes to a solid bar. Because beer and wine generally have a lower alcohol content than other liquors, they may freeze to a relatively harder state. However, bars produced essentially from beer or wine are still relatively soft and do not have the same flaky consistency as pops without alcohol. Thus, there is a need for a hard frozen food product containing a relatively high alcohol content.

### SUMMARY

This document discloses a frozen beverage having a combination of a drug and a gelling agent. The combination is preferably maintained at a temperature of 120 degrees F. for at least one minute. In a some embodiments, the frozen beverage is hard frozen in the form of a popsicle, and contains ethyl alcohol as the drug and pectin as the gelling agent.

In another aspect, methods of producing a frozen food include first cooking a gelling agent and a drug together, then mixing a flavor into the cooked combination. The combination can be dispensed into a freezer pop container and shipped and shelved in an unfrozen state.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a schematic showing steps in the production of a prior art food.

FIG. 2 is a schematic for production of a frozen pop.

Like reference symbols in the various drawings indicate like elements.

### DETAILED DESCRIPTION

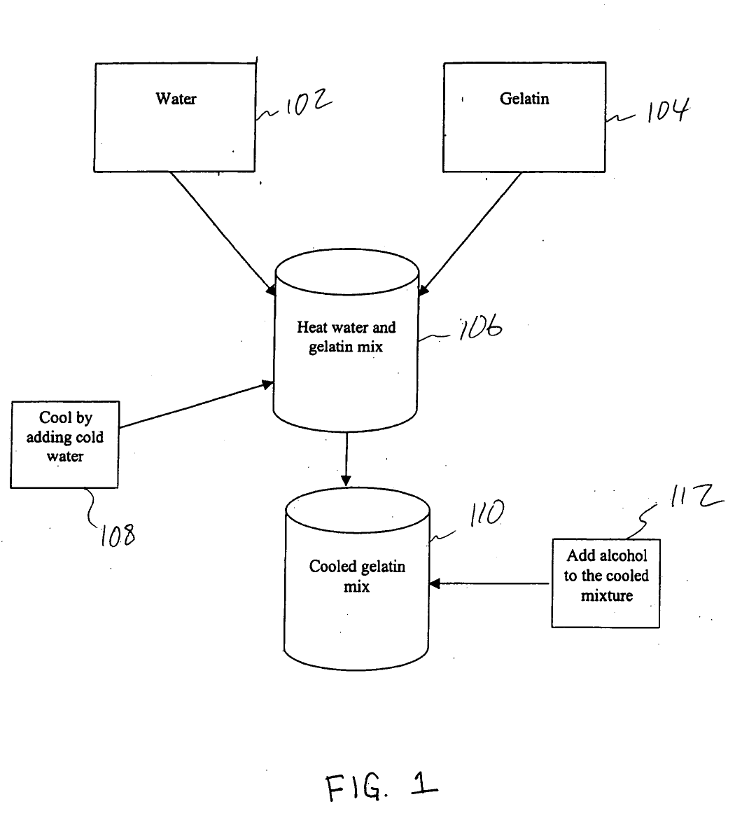

Referring first to FIG. 1, a frozen food product is prepared by combining water 102 with gelatin 104 into a water and gelatin mixture 106, and heating the mixture 106. This can be accomplished by boiling the water 102 and then adding the gelatin 104, which may be flavored. The addition of alcohol 112 occurs after the mixture 106 has been cooled to produce a cooled mixture 110 by adding cold water 108. The mixture 106 may be cooled by other means, however so long as the alcohol 112 is added when the mixture is in a relatively cool state.

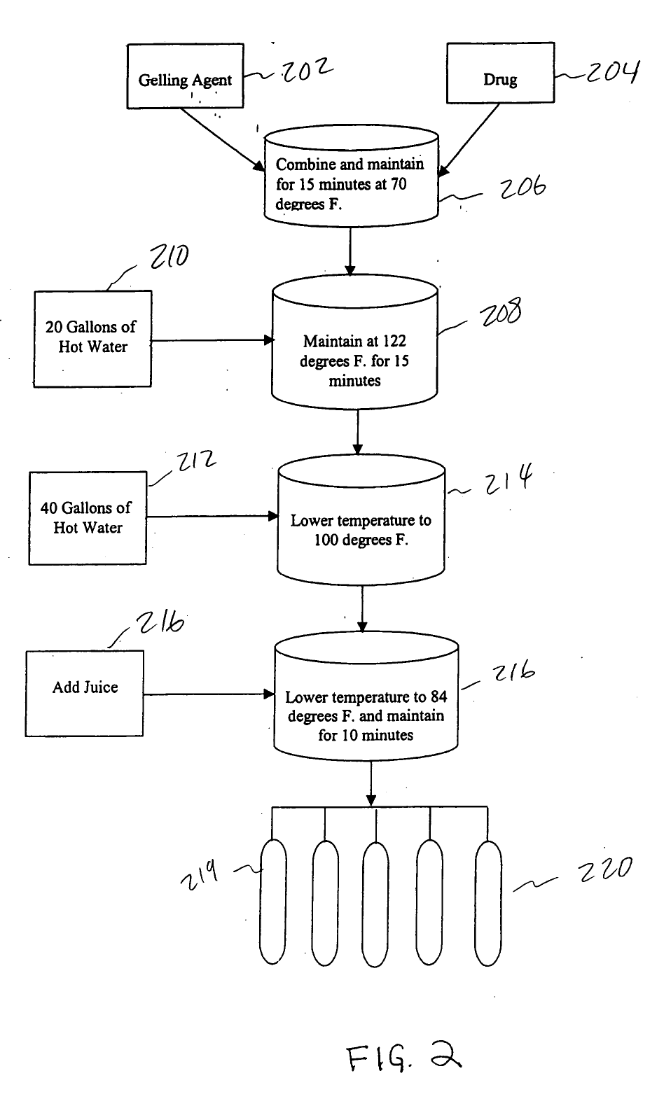

FIG. 2 depicts ingredients and steps in the production of a frozen beverage product 220. First, a gelling agent 202 is combined with a drug 204. The gelling agent 202 is a compound that causes firmness or gelling. Suitable gelling agents 202 include pectin (a polysaccharide found in nearly all plant tissue), cellulose, carrageenan or gelatin. The drug 204 includes any molecule or composition of molecules that alters structure, metabolism, cell cycle and/or function of a diseased or otherwise negatively impacted cell or organ. For example, contemplated drugs 204 include anti-neoplastic drugs (e.g 5-FU, taxol, etc.), anti-metabolites (e.g., tnmethoprim, sulfonamides, etc.), antibiotics (e.g., beta-lactam antibiotics, tetracycline antibiotics, etc.), and anti-viral agents (e.g., ribavirin, T-20, etc.), immunomodulatory agents (e.g., steroids, cytokines, etc.), pro-, and anti-apoptotic agents, receptor blockers (e.g., beta blockers), enzyme inhibitors (e.g., statins), as well as ethanol (i.e. ethyl alcohol).

In some embodiments, the gelling agent 202 and drug 204 are combined into a combination 206 and then maintained for 15 minutes at around 70 degrees F. Next, the drug/agent combination 206 is provided as a heated combination 208 and brought to a temperature of about 122 degrees F. by adding a number of gallons (i.e. 20) of hot water 210. The heated drug/agent combination 208 is maintained at about 122 degrees F. for about 10-20 minutes, and preferably 15 minutes. However, other times and temperatures can be used. For example, it is contemplated that the temperature can range from 105 to 150 degrees F. and the time can range from 5 to 30 minutes. The time and temperature may be related in that a relatively high temperature may require relatively less time, and a relatively low temperature may require relatively more time—all within the ranges stated above.

The term “maintaining” as defined herein means sustaining the heat (at about 122 degrees F.) with the intent to sustain the heat at a consistent level. In an embodiment having an ethyl alcohol, the gelling agent bonds to the alcohol (OH) molecule. In some embodiments, it is preferred that a neutral (i.e. substantially clear and tasteless) alcohol be used such as that produced from grapes or from oranges.

Introduction of additional hot water 212 is used to produce a lower-heated combination 214, i.e. to around 100 degrees F. Following this step, a juice 216 is optionally added to provide flavor and to aid in consistency. A preferable juice 216 contains at least 10% real fruit. The addition of the juice also aids in bringing the temperature of the lower-heated combination 214 down to about 84 degrees F. which is preferably maintained as a cooled combination 216 for about 10 minutes.

For purposes of producing an alcoholic frozen beverage product 220, in some embodiments it may be advantageous to add a flavoring (not shown) to a neutral alcohol mixture in order to better replicate drinks produced with flavored alcohol and/or drink mixes. A neutral mixture can be frozen into units wherein each unit is sufficient for one drink. These additives can help obtain a more consistent flavor and texture, increas the speed within which drinks can be made, and aid in the number of alcoholic beverages consumed and sold.

The mixture is then poured into molds 219 and frozen to form the frozen beverage product 220. The frozen beverage product 220 can be frozen to a hard state (e.g. a fruit pop or ice cube) or to a softer state such as a slush. Additionally, the mixture can be frozen in various containers or molds of various shapes and sizes. For example, it may be advantageous to freeze a mixture in a paper cup and eat it with a spoon rather than from a pop. Another embodiment may include freezing the mixture in the form of an ice cube and using the ice cube in a drink. Such frozen beverages can also be decorative having various colors and even brands or trademarks frozen into them. It is further contemplated that objects (edible and non-edible) can be frozen into a frozen beverage. It is preferred that an alcoholic mixture be placed into liquid brine and cooled to a temperature lower than −20 degrees F.

The result of a mixture according to the steps outlined above is a frozen beverage generally having crystal flakes throughout and a relatively slow melting time compared to other frozen beverages. The alcohol or other drug content of the product can vary widely from 1% or less, to 5, 10, or even 20% or more.

A beverage product may be produced by performing the above steps with the exception of freezing the mixture. Thus, such items can be shipped and sold in an unfrozen state. By allowing such items to be shipped and sold unfrozen, many of the special handling and storage requirements are obviated. A consumer may either freeze the mixture at home or a vendor of the frozen beverage may freeze it before it is bought. Moreover, where a pharmaceutical drug is concerned, the frozen beverage may be dispensed only by a pharmacist or doctor, and it would be more convenient if such items did not require that they be frozen when dispensed. In any event, the beverage product is intended to be frozen before being consumed.

In one particular example, 25 gallons of 48 proof (24%) rum is mixed with 3 quarts of gelling agent (1 quart each of three different agents). The mixture of the rum and gelling agents sits for 5 to 15 minutes at approximately 70 degrees F. Next, 20 gallons of hot water (at approximately 135 degrees F.) is added to the mixture bringing the temperature to about 122 degrees F. for 5 to 15 minutes. In the next step, the temperature of the mixture is brought down to about 100 degrees F. by adding approximately 40 gallons of water. Seventy-five gallons of pineapple juice is added to the mixture which then sits for approximately 10 minutes at around 96 degrees F. At this point, rather than pass the mixture through a cooler system, the mixture was poured into molds at a temperature of about 88 degrees F. The molds are placed into a freezer and frozen to a temperature of −20 degrees F. Additionally, it may become necessary to add a defoamer to reduce foam that may be caused by freezer impeller blades.

Another particular example begins with mixing 25 gallons of 80 proof tequila with three gelling agents. The mixture is maintained at around 70 degrees F. for 15 minutes or more. Next, 20 gallons of hot water (135 degrees F.) is added to the mixture and the mixture is maintained at around 122 degrees F. for at least 15 minutes. Forty gallons of cooler water is added bringing the mixture temperature down to 100 degrees F. before adding 75 gallons of strawberry margarita mix. The mixture is left to sit for around 10 minutes at 84 degrees F. Following this step, the 80 degree F. mixture is poured into molds and frozen to −20 degrees F.

During the process, the gelling agent is bonded to the drug and then the other ingredients (water, sugar, acid, flavoring, juice etc.) bond to the gelling agent. Even in a hard frozen alcoholic beverage, the alcohol does not actually freeze, but is encapsulated in the lattice formed by the other low-temperature ingredients.

Thus, general and specific embodiments and applications of a beverage product have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A frozen beverage product, comprising
a combination of a drug and a gelling agent, the combination maintained at a temperature of at least 120 degrees F. for at least one minute.

2. The frozen beverage of claim 1, wherein the drug is an antibiotic.

3. The frozen beverage of claim 1, wherein the drug is an anti-neoplastic.

4. The frozen beverage of claim 1, wherein the drug is an anti-metabolite.

5. The frozen beverage of claim 1, wherein the drug is an anti-viral agent.

6. The frozen beverage of claim 1, wherein the drug comprises ethanol.

7. The frozen beverage of claim 6, wherein the drug is substantially clear and tasteless.

8. The frozen beverage of claim 6, wherein the drug is a, whiskey.

9. The frozen beverage of claim 6, wherein the drug is a vodka.

10. The frozen beverage of claim 6, wherein the drug is a wine.

11. The frozen beverage of claim 6, wherein the drug is a gin.

12. The frozen beverage of claim 1, wherein the gelling agent comprises pectin.

13. The frozen beverage of claim 1, wherein the gelling agent comprises cellulose.

14. The frozen beverage of claim 1, wherein the gelling agent comprises gelatin.

15. The frozen beverage of claim 1, packaged in a freezer pop container.

16. The frozen beverage of claim 1, hard frozen at the time of consumption.

17. The frozen beverage of claim 1, slush frozen at the time of consumption.

18. The frozen beverage of claim 1, wherein the drug comprises at least 5% of the frozen beverage by weight.

19. A method of producing a frozen food, comprising the ordered steps of: cooking a gelling agent and a drug; and mixing a flavor into the cooked combination.

20. The method of claim 19, further comprising a subsequent step of dispensing the cooked combination into a freezer pop container.
